(19) United States
(12) Patent Application Publication
(10) Pub. No.: US 2023/0300313 A1
(43) Pub. Date: Sep. 21, 2023

(54) Systems With Displays and Sensors

(71) Applicant: Apple Inc., Cupertino, CA (US)

(72) Inventors: Jeffrey C. Olson, San Francisco, CA (US); Anthony S. Montevirgen, Redwood City, CA (US); David A. Schmuck, Raymore, MO (US); Divakar Singamsetty, San Jose, CA (US); Edward S. Huo, Sunnyvale, CA (US); Jason L. Slupeiks, Sunnyvale, CA (US); Jeremy C. Franklin, San Francisco, CA (US); Ritu Shah, Sunnyvale, CA (US); Timothy Y. Chang, Campbell, CA (US); Yamile Pariente Monalli, Sunny Isles Beach, FL (US); Jason C. Sauers, Sunnyvale, CA (US)

(21) Appl. No.: 18/179,319

(22) Filed: Mar. 6, 2023

Related U.S. Application Data
(63) Continuation of application No. PCT/US2021/049402, filed on Sep. 8, 2021.
(60) Provisional application No. 63/081,222, filed on Sep. 21, 2020.

(51) Int. Cl. H04N 13/344; H04N 13/305; H04N 13/239; H04N 13/254; H04N 23/20; H04N 23/71; H04N 13/366; H04N 23/74

(52) U.S. Cl. CPC H04N 13/344; H04N 13/305; H04N 13/239; H04N 13/254; H04N 23/20; H04N 23/71; H04N 13/366; H04N 23/74; G02B 30/27

(57) ABSTRACT

A head-mounted device may have a head-mounted support structure. Rear-facing displays may present images to eye boxes at the rear of the head-mounted support structure. A forward-facing publicly viewable display may be supported on a front side of the head-mounted support structure facing away from the rear-facing displays. The forward-facing display may have pixels that form an active area in which images are displayed and may have a ring-shaped inactive border area that surrounds the pixels. The active area may have a curved peripheral edge with a nose bridge recess. The inactive border area may have a periphery that runs parallel to the peripheral edge of the active area. The forward-facing display may have a cover layer with a developable surface overlapping the active area and a ring-shaped surface of compound curvature that overlaps the inactive area. Optical components may operate through the cover layer in the inactive area.

This application is a continuation of international patent application No. PCT/US2021/049402, filed Sep. 8, 2021, which claims priority to U.S. provisional patent application No. 63/081,222, filed Sep. 21, 2020, which are hereby incorporated by reference herein in their entireties.

### FIELD

This relates generally to electronic devices, and, more particularly, to electronic devices such as head-mounted devices.

### BACKGROUND

Electronic devices such as head-mounted devices may have input-output components. The input-output components may include components such as displays and sensors.

### SUMMARY

A head-mounted device may have a head-mounted support structure. Rear-facing displays may present images to eye boxes at the rear of the head-mounted support structure while the head-mounted support structure is being worn by a user. The head-mounted support structure may have a curved rear surface that wraps around a user's head.

A forward-facing publicly viewable display may be supported on a front side of the head-mounted support structure facing away from the rear-facing displays. The forward-facing display may have a curved shape that wraps around the front of the head-mounted support structure and the user's head.

The forward-facing display may have pixels that form an active area in which images are displayed and may have a ring-shaped inactive border region that surrounds the pixels. The active area may have a curved peripheral edge with a nose bridge recess. The outline of the active area on each side of the display may have a teardrop shape or other curved shape. The periphery of the inactive border area may run parallel to the peripheral edge of the active area.

The forward-facing display may have a display cover layer with a developable surface overlapping the active area. The pixels in the active area may be supported on a flexible display substrate that is bent about a bend axis that runs vertically through the middle of the support structure. The bent flexible display may have a developable surface that rests against or adjacent to the inner surface of the display cover layer or that rests against or adjacent to the inner surface of a shroud canopy layer. If desired, the bent flexible display may be attached to a developable inner surface of the display cover layer and the display cover layer may have a corresponding outer surface overlapping the display that is characterized by compound curvature.

The edges of the display cover layer may be swept rearward from the active area and may be characterized by curved cross-sectional profiles. In an illustrative configuration, the surface of the cover layer in the ring-shaped inactive area has compound curvature. The surface of the display cover layer in the active area may be a developable surface or may have compound curvature

Optical components may operate through the cover layer in the inactive area. The optical components may include a flicker sensor, an ambient light sensor, cameras, three-dimensional image sensors such as structured light three-dimensional sensors and a time-of-flight three-dimensional image sensor, and an infrared illumination system configured to provide infrared illumination for tracking cameras in dim ambient lighting conditions.

### BRIEF DESCRIPTION OF THE DRAWINGS

FIG. 1 is a side view of an illustrative electronic device such as a head-mounted device in accordance with an embodiment.

FIG. 2 is schematic diagram of an illustrative system with an electronic device in accordance with an embodiment.

FIG. 3 is a front view of an illustrative head-mounted device in accordance with an embodiment.

FIG. 4 is a cross-sectional top view of an illustrative head-mounted device in accordance with an embodiment.

FIG. 5A is a cross-sectional side view of an illustrative head-mounted device in accordance with an embodiment.

FIG. 5B is a cross-sectional side view of another illustrative head-mounted device in accordance with an embodiment.

FIG. 6 is a front view of an upper left portion of an illustrative head-mounted device with a publicly viewable display in accordance with an embodiment.

FIGS. 7, 8, 9, 10, 11, and 12 are front views of portions of an illustrative head-mounted device in accordance with embodiments.

FIG. 13 is an exploded cross-sectional top view of a portion of an illustrative head-mounted device in accordance with an embodiment.

FIG. 14 is a cross-sectional side view of a portion of an illustrative head-mounted device with a display in accordance with an embodiment.

FIGS. 15, 16, and 17 are cross-sectional side views of illustrative display cover layers overlapping illustrative optical components in accordance with embodiments.

### DETAILED DESCRIPTION

A head-mounted device may include a head-mounted support structure that allows the device to be worn on the head of a user. The head-mounted device may have displays that are supported by the head-mounted support structure for presenting a user with visual content. The displays may include rear-facing displays that present images to eye boxes at the rear of the head-mounted support structure. The displays may also include a forward-facing display. The forward-facing display may be mounted to the front of the head-mounted support structure and may be viewed by the user when the head-mounted device is not being worn on the user's head. The forward-facing display, which may sometimes be referred to as a publicly viewable display, may also be viewable by other people in the vicinity of the head-mounted device.

Optical components such as image sensors and other light sensors may be provided in the head-mounted device. In an illustrative configuration, optical components are mounted under peripheral portions of a display cover layer that protects the forward-facing display.

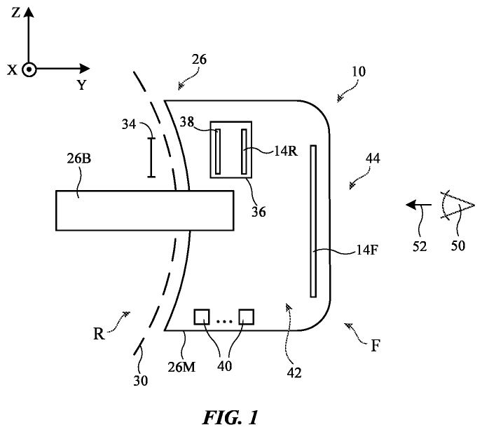

FIG. 1 is a side view of an illustrative head-mounted electronic device. As shown in FIG. 1, head-mounted device 10 may include head-mounted support structure 26. Support structure 26 may have walls or other structures that separate an interior region of device 10 such as interior region 42 from an exterior region surrounding device 10 such as exterior region 44. Electrical components 40 (e.g., integrated circuits, sensors, control circuitry, light-emitting diodes, lasers, and other light-emitting devices, other control circuits and input-output devices, etc.) may be mounted on printed circuits and/or other structures within device 10 (e.g., in interior region 42).

To present a user with images for viewing from eye boxes such as eye box 34, device 10 may include rear-facing displays such as display 14R and lenses such as lens 38. These components may be mounted in optical modules such as optical module 36 (e.g., a lens barrel) to form respective left and right optical systems. There may be, for example, a left rear-facing display for presenting an image through a left lens to a user's left eye in a left eye box and a right rear-facing display for presenting an image to a user's right eye in a right eye box. The user's eyes are located in eye boxes 34 at rear side R of device 10 when structure 26 rests against the outer surface (face surface 30) of the user's face.

Support structure 26 may include a main support structure such as main housing portion 26M (sometimes referred to as a main portion). Main housing portion 26M may extend from front side F of device 10 to opposing rear side R of device 10. On rear side R, main housing portion 26M may have cushioned structures to enhance user comfort as portion 26M rests against face surface 30. If desired, support structure 26 may include optional head straps such as strap 26B and/or other structures that allow device 10 to be worn on a head of a user.

Device 10 may have a publicly viewable front-facing display such as display 14F that is mounted on front side F of main housing portion 26M. Display 14F may be viewable to the user when the user is not wearing device 10 and/or may be viewable by others in the vicinity of device 10. Display 14F may, as an example, be visible on front side F of device 10 by an external viewer such as viewer 50 who is viewing device 10 in direction 52.

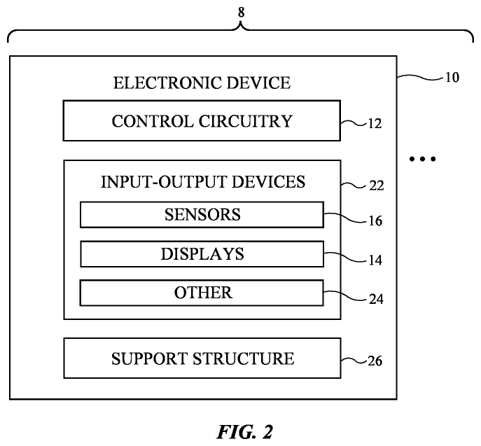

A schematic diagram of an illustrative system that may include a head-mounted device is shown in FIG. 2. As shown in FIG. 2, system 8 may have one or more electronic devices 10. Devices 10 may include a head-mounted device (e.g., device 10 of FIG. 1), accessories such as controllers and headphones, computing equipment (e.g., a cellular telephone, tablet computer, laptop computer, desktop computer, and/or remote computing equipment that supplies content to a head-mounted device), and/or other devices that communicate with each other.

Each electronic device 10 may have control circuitry 12. Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involving the adjustment of the components of device 10 using control signals, etc.). Control circuitry 12 may include wired and wireless communications circuitry. For example, control circuitry 12 may include radio-frequency transceiver circuitry such as cellular telephone transceiver circuitry, wireless local area network transceiver circuitry (e.g., WiFi® circuitry), millimeter wave transceiver circuitry, and/or other wireless communications circuitry.

During operation, the communications circuitry of the devices in system 8 (e.g., the communications circuitry of control circuitry 12 of device 10) may be used to support communication between the electronic devices. For example, one electronic device may transmit video data, audio data, control signals, and/or other data to another electronic device in system 8. Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Each device 10 in system 8 may include input-output devices 22. Input-output devices 22 may be used to allow a user to provide device 10 with user input. Input-output devices 22 may also be used to gather information on the environment in which device 10 is operating. Output components in devices 22 may allow device 10 to provide a user with output and may be used to communicate with external electrical equipment.

As shown in FIG. 2, input-output devices 22 may include one or more displays such as displays 14. Displays 14 may include rear facing displays such as display 14R of FIG. 1. Device 10 may, for example, include left and right components such as left and right scanning mirror display devices or other image projectors, liquid-crystal-on-silicon display devices, digital mirror devices, or other reflective display devices, left and right display panels based on light-emitting diode pixel arrays (e.g., organic light-emitting displays with polymer or semiconductor substrates or display devices based on pixel arrays formed from crystalline semiconductor light-emitting diode dies), liquid crystal display panels, and/or or other left and right display devices that provide images to left and right eye boxes for viewing by the user's left and right eyes, respectively. Display components such as these (e.g., an organic light-emitting display with a flexible polymer substrate or a display based on a pixel array formed from crystalline semiconductor light-emitting diode dies on a flexible substrate) may also be used in forming a forward-facing display for device 10 such as forward-facing display 14F of FIG. 1 (sometimes referred to as a front-facing display, front display, or publicly viewable display).

During operation, displays 14 (e.g., displays 14R and/or 14F) may be used to display visual content for a user of device 10 (e.g., still and/or moving images including pictures and pass-through video from camera sensors, text, graphics, movies, games, and/or other visual content). The content that is presented on displays 14 may, for example, include virtual objects and other content that is provided to displays 14 by control circuitry 12. This virtual content may sometimes be referred to as computer-generated content. Computer-generated content may be displayed in the absence of real-world content or may be combined with real-world content. In some configurations, a real-world image may be captured by a camera (e.g., a forward-facing camera, sometimes referred to as a front-facing camera) and computer-generated content may be electronically overlaid on portions of the real-world image (e.g., when device 10 is a pair of virtual reality goggles).

Input-output circuitry 22 may include sensors 16. Sensors 16 may include, for example, three-dimensional sensors (e.g., three-dimensional image sensors such as structured light sensors that emit beams of light and that use two-dimensional digital image sensors to gather image data for three-dimensional images from dots or other light spots that are produced when a target is illuminated by the beams of light, binocular three-dimensional image sensors that gather three-dimensional images using two or more cameras in a binocular imaging arrangement, three-dimensional lidar (light detection and ranging) sensors, sometimes referred to as time-of-flight cameras or three-dimensional time-of-flight cameras, three-dimensional radio-frequency sensors, or other sensors that gather three-dimensional image data), cameras (e.g., two-dimensional infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, capacitive proximity sensors, light-based (optical) proximity sensors, other proximity sensors, force sensors (e.g., strain gauges, capacitive force sensors, resistive force sensors, etc.), sensors such as contact sensors based on switches, gas sensors, pressure sensors, moisture sensors, magnetic sensors, audio sensors (microphones), ambient light sensors, flicker sensors that gather temporal information on ambient lighting conditions such as the presence of a time-varying ambient light intensity associated with artificial lighting, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), and/or other sensors.

User input and other information may be gathered using sensors and other input devices in input-output devices 22. If desired, input-output devices 22 may include other devices 24 such as haptic output devices (e.g., vibrating components), light-emitting diodes, lasers, and other light sources (e.g., light-emitting devices that emit light that illuminates the environment surrounding device 10 when ambient light levels are low), speakers such as ear speakers for producing audio output, circuits for receiving wireless power, circuits for transmitting power wirelessly to other devices, batteries and other energy storage devices (e.g., capacitors), joysticks, buttons, and/or other components.

As described in connection with FIG. 1, electronic device 10 may have head-mounted support structures such as head-mounted support structure 26 (e.g., head-mounted housing structures such as housing walls, straps, etc.). The head-mounted support structure may be configured to be worn on a head of a user (e.g., against the user's face covering the user's eyes) during operation of device 10 and may support displays 14, sensors 16, other components 24, other input-output devices 22, and control circuitry 12 (see, e.g., components 40 and optical module 36 of FIG. 1).

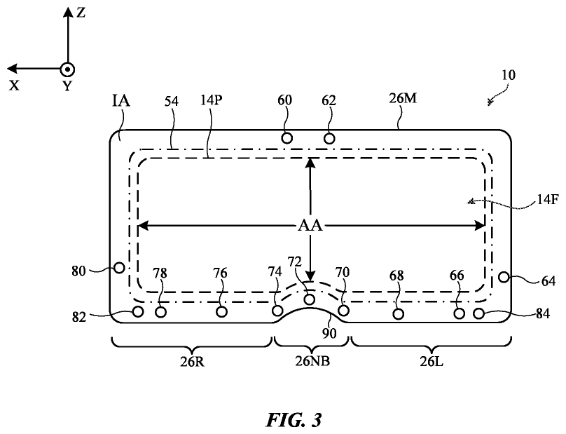

FIG. 3 is a front view of device 10 in an illustrative configuration in which device 10 has a publicly viewable display such as forward-facing display 14F. As shown in FIG. 3, support structure 26M of device 10 may have right and left portions such as portions 26R and 26L that are coupled by an interposed nose bridge portion such as portion 26NB. Portion 26NB may have a curved exterior surface such as nose bridge surface 90 that is configured to receive and rest upon a user's nose to help support main housing portion 26M on the head of the user.

Display 14F may have an active area such as active area AA that is configured to display images and an inactive area IA that does not display images. The outline of active area AA may be rectangular, rectangular with rounded corners, may have teardrop shaped portions on the left and right sides of device 10, may have a shape with straight edges, a shape with curved edges, a shape with a peripheral edge that has both straight and curved portions, and/or other suitable outlines. As shown in FIG. 3, active area AA may have a curved recessed portion at nose bridge portion 26NB of main housing portion 26. The presence of the nose-shaped recess in active area AA may help fit active area AA within the available space of housing portion 26M without overly limiting the size of active area AA.

Active area AA contains an array of pixels. The pixels may be, for example, light-emitting diode pixels formed from thin-film organic light-emitting diodes or crystalline semiconductor light-emitting diode dies (sometimes referred to as micro-light-emitting diodes) on a flexible display panel substrate. Configurations in which display 14F uses other display technologies may also be used, if desired. Illustrative arrangements in which display 14 is formed from a light-emitting diode display such as an organic light-emitting diode display that is formed on a flexible substrate (e.g., a substrate formed from a bendable layer of polyimide or a sheet of other flexible polymer) may sometimes be described herein as an example. The pixels of active area AA may be formed on a display device such as display panel 14P of FIG. 3 (e.g., a flexible organic light-emitting diode display panel). In some configurations, the outline of panel 14P may have a peripheral edge that contains straight segments or a combination of straight and curved segments. Configurations in which the entire outline of panel 14P is characterized by a curved peripheral edge may also be used.

Display 14F may have an inactive area such as inactive area IA that is free of pixels and that does not display images. Inactive area IA may form an inactive border region that runs along one more portions of the peripheral edge of active area AA. In the illustrative configuration of FIG. 3, inactive area IA has a ring shape that surrounds active area AA. In this type of arrangement, the width of inactive area IA may be relatively constant and the inner and outer edges of area IA may be characterized by straight and/or curved segments or may be curved along their entire lengths. For example, the outer edge of area IA (e.g., the periphery of display 14F) may have a curved outline that runs parallel to the curved edge of active area AA.

In some configurations, device 10 may operate with other devices in system 8 (e.g., wireless controllers and other accessories). These accessories may have magnetic sensors that sense the direction and intensity of magnetic fields. Device 10 may have one or more electromagnets configured to emit a magnetic field. The magnetic field can be measured by the wireless accessories near device 10, so that the accessories can determine their orientation and position relative to device 10. This allows the accessories to wirelessly provide device 10 with real-time information on their current position, orientation, and movement so that the accessories can serve as wireless controllers. The accessories may include wearable devices, handled devices, and other input devices.

In an illustrative configuration, device 10 may have a coil such as illustrative coil 54 that runs around the perimeter of display 14F (e.g., under inactive area IA or other portion of display 14F). Coil 54 may have any suitable number of turns (e.g., 1-10, at least 2, at least 5, at least 10, 10-50, fewer than 100, fewer than 25, fewer than 6, etc.). These turns may be formed from metal traces on a substrate, may be formed from wire, and/or may be formed from other conductive lines. During operation, control circuitry 12 may supply coil 54 with an alternating-current (AC) drive signal. The drive signal may have a frequency of at least 1 kHz, at least 10 kHz, at least 100 kHz, at least 1 MHz, less than 10 MHz, less than 3 MHz, less than 300 kHz, or less than 30 kHz (as examples). As AC current flows through coil 54, a corresponding magnetic field is produced in the vicinity of device 10. Electronic devices such as wireless controllers with magnetic sensors that are in the vicinity of device 10 may use the magnetic field as a reference so that the wireless controllers can determine their orientation, position, and/or movement while being moved relative to device 10 to provide device 10 with input.

Consider, as an example, a handheld wireless controller that is used in controlling the operation of device 10. During operation, device 10 uses coil 54 to emit a magnetic field. As the handheld wireless controller is moved, the magnetic sensors of the controller can monitor the location of the controller and the movement of the controller relative to device 10 by monitoring the strength, orientation, and change to the strength and/or orientation of the magnetic field emitted by coil 54 as the controller is moved through the air by the user. The electronic device can then wirelessly transmit information on the location and orientation of the controller to device 10. In this way, a handheld controller, wearable controller, or other external accessory can be manipulated by a user to provide device 10 with air gestures, pointing input, steering input, and/or other user input.

Device 10 may have components such as optical components (e.g., optical sensors among sensors 16 of FIG. 2). These components may be mounted in any suitable location on head-mounted support structure 26 (e.g. on head strap 26B, on main housing portion 26M, etc.). Optical components and other components may face rearwardly (e.g., when mounted on the rear face of device 10), may face to the side (e.g. to the left or right), may face downwardly or upwardly, may face to the front of device 10 (e.g., when mounted on the front face of device 10), may be mounted so as to point in any combination of these directions (e.g., to the front, to the right, and downward) and/or may be mounted in other suitable orientations. In an illustrative configuration, at least some of the components of device 10 are mounted so as to face outwardly to the front (and optionally to the sides and/or up and down). For example, forward-facing cameras for pass-through video may be mounted on the left and right sides of the front of device 10 in a configuration in which the cameras diverge slightly along the horizontal dimension so that the fields of view of these cameras overlap somewhat while capturing a wide-angle image of the environment in front of device 10. The captured image may, if desired, include portions of the user's surroundings that are below, above, and to the sides of the area directly in front of device 10.

To help hide components such as optical components from view from the exterior of device 10, it may be desirable to cover some or all of the components with cosmetic covering structures. The covering structures may include transparent portions (e.g., optical component windows) that are characterized by sufficient optical transparency to allow overlapped optical components to operate satisfactorily. For example, an ambient light sensor may be covered with a layer that appears opaque to an external viewer to help hide the ambient light sensor from view, but that allows sufficient ambient light to pass to the ambient light sensor for the ambient light sensor to make a satisfactory ambient light measurement. As another example, an optical component that emits infrared light may be overlapped with a visibly opaque material that is transparent to infrared light.

In an illustrative configuration, optical components for device 10 may be mounted in inactive area IA of FIG. 3 and cosmetic covering structures may be formed in a ring shape overlapping the optical components in inactive area IA. Cosmetic covering structures may be formed from ink, polymer structures, structures that include metal, other materials, and/or combinations of these materials. In an illustrative configuration, a cosmetic covering structure may be formed from a ring-shaped member having a footprint that matches the footprint of inactive area IA. If, for example, active area AA has left and right portions with teardrop shapes, the ring-shaped member may have curved edges that follow the curved periphery of the teardrop-shaped portions of active area AA. The ring-shaped member may be formed from one or more polymer structures (e.g., the ring-shaped member may be formed from a polymer ring). Because the ring-shaped member can help hide overlapped components from view, the ring-shaped member may sometimes be referred to as a shroud or ring-shaped shroud member. The outward appearance of the shroud or other cosmetic covering structures may be characterized by a neutral color (white, black, or gray) or a non-neutral color (e.g., blue, red, green, gold, rose gold, etc.).

Display 14F may, if desired, have a protective display cover layer. The cover layer may overlap active area AA and inactive area IA (e.g., the entire front surface of device 10 as viewed from direction 52 of FIG. 1 may be covered by the cover layer). The cover layer, which may sometimes be referred to as a housing wall or transparent housing wall, may have a rectangular outline, an outline with teardrop portions, an oval outline, or other shape with curved and/or straight edges.

The cover layer may be formed from a transparent material such as glass, polymer, transparent crystalline material such as sapphire, clear ceramic, other transparent materials, and/or combinations of these materials. As an example, a protective display cover layer for display 14F may be formed from safety glass (e.g., laminated glass that includes a clear glass layer with a laminated polymer film). Optional coating layers may be applied to the surfaces of the display cover layer. If desired, the display cover layer may be chemically strengthened (e.g., using an ion-exchange process to create an outer layer of material under compressive stress that resists scratching). In some configurations, the display cover layer may be formed from a stack of two or more layers of material (e.g., first and second structural glass layers, a rigid polymer layer coupled to a glass layer or another rigid polymer layer, etc.) to enhance the performance of the cover layer.

In active area AA, the display cover layer may overlap the pixels of display panel 14P. The display cover layer in active area AA is preferably transparent to allow viewing of images presented on display panel 14P. In inactive area IA, the display cover layer may overlap the ring-shaped shroud or other cosmetic covering structure. The shroud and/or other covering structures (e.g., opaque ink coatings on the inner surface of the display cover layer and/or structures) may be sufficiently opaque to help hide some or all of the optical components in inactive area IA from view. Windows may be provided in the shroud or other cosmetic covering structures to help ensure that the optical components that are overlapped by these structures operate satisfactorily. Windows may be formed from holes, may be formed from areas of the shroud or other cosmetic covering structures that have been locally thinned to enhance light transmission, may be formed from window members with desired light transmission properties that have been inserted into mating openings in the shroud, and/or may be formed from other shroud window structures.

In the example of FIG. 3, device 10 includes optical components such as optical components 60, 62, 64, 66, 68, 70, 72, 74, 76, 78, and 80 (as an example). Each of these optical components (e.g., optical sensors selected from among sensors 16 of FIG. 2, light-emitting devices, etc.) may be configured to detect light and, if desired to emit light (e.g., ultraviolet light, visible light, and/or infrared light).

In an illustrative configuration, optical component 60 may sense ambient light (e.g., visible ambient light). In particular, optical component 60 may have a photodetector that senses variations in ambient light intensity as a function of time. If, as an example, a user is operating in an environment with an artificial light source, the light source may emit light at a frequency associated with its source of wall power (e.g., alternating-current mains power at 60 Hz). The photodetector of component 60 may sense that the artificial light from the artificial light source is characterized by 60 Hz fluctuations in intensity. Control circuitry 12 can use this information to adjust a clock or other timing signal associated with the operation of image sensors in device 10 to help avoid undesired interference between the light source frequency and the frame rate or other frequency associated with image capture operations. Control circuitry 12 can also use measurements from component 60 to help identify the presence of artificial lighting and the type of artificial lighting that is present. In this way, control circuitry 12 can detect the presence of lights such as fluorescent lights or other lights with known non-ideal color characteristics and can make compensating color cast adjustments (e.g., white point adjustments) to color-sensitive components such as cameras and displays. Because optical component 60 may measure fluctuations in light intensity, component 60 may sometimes be referred to as a flicker sensor or ambient light frequency sensor.

Optical component 62 may be an ambient light sensor. The ambient light sensor may include one or more photodetectors. In a single-photodetector configuration, the ambient light sensor may be a monochrome sensor that measures ambient light intensity. In a multi-photodetector configuration, each photodetector may be overlapped by an optical filter that passes a different band of wavelengths (e.g. different visible and/or infrared passbands). The optical filter passbands may overlap at their edges. This allows component 62 to serve as a color ambient light sensor that measures both ambient light intensity and ambient light color (e.g., by measuring color coordinates for the ambient light). During operation of device 10, control circuitry 12 can take action based on measured ambient light intensity and color. As an example, the white point of a display or image sensor may be adjusted or other display or image sensor color adjustments may be made based on measured ambient light color. The intensity of a display may be adjusted based on light intensity. For example, the brightness of display 14F may be increased in bright ambient lighting conditions to enhance the visibility of the image on the display and the brightness of display 14F may be decreased in dim lighting conditions to conserve power. Image sensor operations and/or light source operations may also be adjusted based on ambient light readings.

The optical components in active area IA may also include components along the sides of device 10 such as components 80 and 64. Optical components 80 and 64 may be pose-tracking cameras that are used to help monitor the orientation and movement of device 10. Components 80 and 64 may be visible light cameras (and/or cameras that are sensitive at visible and infrared wavelengths) and may, in conjunction with an inertial measurement unit, form a visual inertial odometry (VIO) system.

Optical components 78 and 66 may be visible-light cameras that capture real-time images of the environment surrounding device 10. These cameras, which may sometimes be referred to as scene cameras or pass-through-video cameras, may capture moving images that are displayed in real time to displays 14R for viewing by the user when the user's eyes are located in eye boxes 34 at the rear of device 10. By displaying pass-through images (pass-through video) to the user in this way, the user may be provided with real-time information on the user's surroundings. If desired, virtual content (e.g. computer-generated images) may be overlaid over some of the pass-through video. Device 10 may also operate in a non-pass-through-video mode in which components 78 and 66 are turned off and the user is provided only with movie content, game content, and/or other virtual content that does not contain real-time real-world images.

Input-output devices 22 of device 10 may gather user input that is used in controlling the operation of device 10. As an example, a microphone in device 10 may gather voice commands. Buttons, touch sensors, force sensors, and other input devices may gather user input from a user's finger or other external object that is contacting device 10. In some configurations, it may be desirable to monitor a user's hand gestures or the motion of other user body parts. This allows the user's hand locations or other body part locations to be replicated in a game or other virtual environment and allows the user's hand motions to serve as hand gestures (air gestures) that control the operation of device 10. User input such as hand gesture input can be captured using cameras that operate at visible and infrared wavelengths such as tracking cameras (e.g., optical components 76 and 68). Tracking cameras such as these may also track fiducials and other recognizable features on controllers and other external accessories (additional devices 10 of system 8) during use of these controllers in controlling the operation of device 10. If desired, tracking cameras can help determine the position and orientation of a handheld controller or wearable controller that senses its location and orientation by measuring the magnetic field produced by coil 54. The use of tracking cameras may therefore help track hand motions and controller motions that are used in moving pointers and other virtual objects being displayed for a user and can otherwise assist in controlling the operation of device 10.

Tracking cameras may operate satisfactorily in the presence of sufficient ambient light (e.g., bright visible ambient lighting conditions). In dim environments, supplemental illumination may be provided by supplemental light sources such as supplemental infrared light sources (e.g., optical components 82 and 84). The infrared light sources may each include one or more light-emitting devices (light-emitting diodes or lasers) and may each be configured to provide fixed and/or steerable beams of infrared light that serve as supplemental illumination for the tracking cameras. If desired, the infrared light sources may be turned off in bright ambient lighting conditions and may be turned on in response to detection of dim ambient lighting (e.g., using the ambient light sensing capabilities of optical component 62).

Three-dimensional sensors in device 10 may be used to perform biometric identification operations (e.g., facial identification for authentication), may be used to determine the three-dimensional shapes of objects in the user's environment (e.g., to map the user's environment so that a matching virtual environment can be created for the user), and/or to otherwise gather three-dimensional content during operation of device 10. As an example, optical components 74 and 70 may be three-dimensional structured light image sensors. Each three-dimensional structured light image sensor may have one or more light sources that provide structured light (e.g., a dot projector that projects an array of infrared dots onto the environment, a structured light source that produces a grid of lines, or other structured light component that emits structured light). Each of the three-dimensional structured light image sensors may also include a flood illuminator (e.g., a light-emitting diode or laser that emits a wide beam of infrared light). Using flood illumination and structured light illumination, optical components 74 and 70 may capture facial images, images of objects in the environment surrounding device 10, etc.

Optical component 72 may be an infrared three-dimensional time-of-flight camera that uses time-of-flight measurements on emitted light to gather three-dimensional images of objects in the environment surrounding device 10. Component 72 may have a longer range and a narrower field of view than the three-dimensional structured light cameras of optical components 74 and 70. The operating range of component 72 may be 30 cm to 7 m, 60 cm to 6 m, 70 cm to 5 m, or other suitable operating range (as examples).

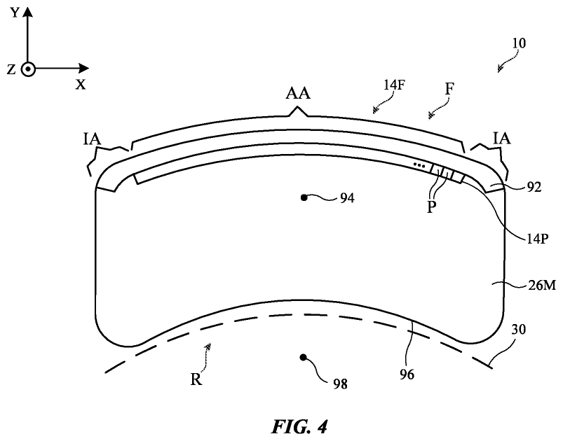

FIG. 4 is a top view of device 10 in an illustrative arrangement in which display 14F and main housing portion 26M have been configured to curve about the curved surface of a user's face (curved face surface 30). In particular, rear surface 96 of housing portion 26M on rear side R of device 10 may have a curved shape that is bent about axis 98 (e.g., an axis parallel to the vertical Z axis in the example of FIG. 4). By wrapping housing portion 26M smoothly about the curved surface of the user's head, comfort may be enhanced when wearing device 10.

As shown in FIG. 4, display 14F and other structures on the front of device 10 may have a protective cover layer such as display cover layer 92 (e.g., a front portion of housing portion 26M, which may sometimes be referred to as a front housing wall, transparent dielectric housing wall, or dielectric housing member). In some embodiments, display cover layer 92 may include areas that are characterized by curved surfaces that can be flattened into a plane without distortion (sometimes referred to as developable surfaces or curved surfaces without compound curvature). Display cover layer 92 may also include areas that are characterized by compound curvature (e.g., surfaces that can only be flattened into a plane with distortion, sometimes referred to as non-developable surfaces).

In active area AA of display 14F, cover layer 92 overlaps an array of pixels P in display panel 14P. In inactive area IA, cover layer 92 does not overlap any pixels, but may overlap optical components such as the optical components shown in FIG. 3. To help reduce the size and weight of device 10, display 14F may have a curved shape that wraps around the front of the user's head parallel to face surface 30 and parallel to curved rear surface 96 of housing portion 26M. For example, display panel 14P may have a flexible substrate that allows panel 14P to bend about bend axis 94 (e.g., a bend axis that is parallel to the Z axis in the example of FIG. 4). In active area AA of display 14F, display cover layer 92 may have an inner surface with a curved cross-sectional profile that conforms to bent display panel 14P and a corresponding curved outer surface. In inactive area IA, display cover layer 92 may also be curved (e.g., with a tighter bend radius and more curvature than in active area AA). If desired, a polymer layer (sometimes referred to as a shroud canopy or polymer member) may be interposed between display cover layer 92 and display panel 14P. The polymer layer may be separated from the pixels of panel 14P by an air gap and may be separated from the inner surface of display cover layer 92 by an air gap (as an example).

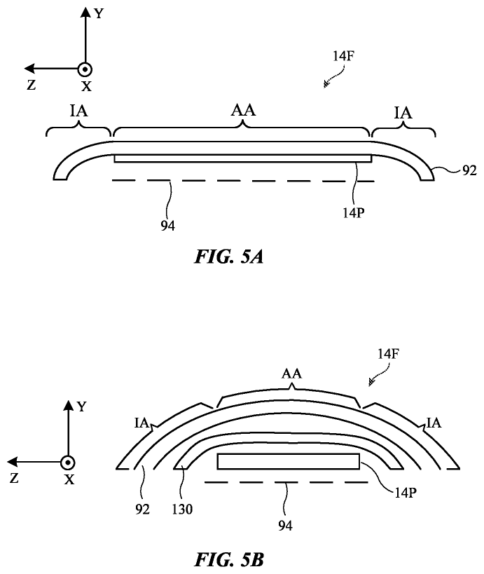

FIG. 5A is a cross-sectional side view of display 14F viewed in the −X direction. As shown in FIG. 5A, the cross-sectional profile of display panel 14P (in planes parallel to the YZ plane) may, in an illustrative configuration, be straight rather than curved. This may help prevent wrinkling or other distortion to the flexible substrate material of display panel 14P as display panel 14P is bent about bend axis 94 to wrap around the curved surface of the user's face. Display panel 14P may, in this example, have a developable surface (e.g., a surface that has a curved cross-sectional profile but that does not have any compound curvature). Panel 14P of FIG. 5A may be attached to the inner surface of layer 92 (e.g., with adhesive). In this scenario, the inner surface of layer 92 may be a developable surface that mates with the outwardly facing developable surface of panel 14P. The corresponding outer surface of layer 92 in active area AA may be a developable surface or may be a surface of compound curvature. In inactive area IA, layer 92 may have inner and/or outer surfaces of compound curvature and/or the inner and/or outer surfaces may be developable surfaces. If desired, the entire outer surface of layer 92 may have compound curvature (both in active area AA and in inactive area IA), the inner surface of layer 92 in active area AA may be a developable surface to which panel 14P is laminated with adhesive, and the inner surface of layer 92 in inactive area IA may have compound curvature and/or may be a developable surface.

Another illustrative configuration for display 14F is shown in FIG. 5B. As shown in the cross-sectional side view of FIG. 5B, display cover layer 92 may, if desired, have a cross-sectional profile that is curved across all of layer 92. With this type of arrangement, the surface of inactive area IA of display cover layer 92 may have compound curvature and active area AA of display cover layer 92 may have compound curvature (e.g., layer 92 may be free of any areas with developable surfaces). A polymer layer such as polymer layer 130, which may sometimes be referred to as a shroud or shroud canopy, may be interposed between the inner surface of display cover layer 92 and the opposing outer surface of display panel 14P. The outer surface of display panel 14P may be a developable surface (e.g., display panel 14P may be bent about axis 94). In active area AA, where polymer layer 130 overlaps the pixels of panel 14P, polymer layer 130 may also be bent about axis 94 (e.g., the inner and outer surfaces of polymer layer 130 in active area AA may be developable surfaces). In inactive area IA, the inner and outer surfaces of polymer layer 130 may have compound curvature. Air gaps may separate panel 14P from the inner surface of layer 130 and may separate the outer surface of layer 130 from the inner surface of layer 92.

If desired, other arrangements for layer 130 may be used. For example, the side of layer 130 facing display panel 14P may have a developable surface in active area AA, whereas the side of layer 130 facing layer 92 may have compound curvature in active area AA (e.g., layer 130 may have a non-uniform thickness). Layer 92 may also have different configurations. For example, the outer surface of layer 92 may have compound curvature, whereas the inner surface of layer 92 in active area AA and/or in area IA may be a developable surface. Other arrangements in which layer 92 and/or layer 130 have variable thicknesses may also be used. In inactive area IA, multiple polymer structures may be joined. For example, in area IA, a ring-shaped polymer member, sometimes referred to as a shroud trim, may be joined to layer 130, which may form a shroud canopy member that extends across the entire front face of device 10. The shroud trim and shroud canopy may, if desired, sometimes be referred to individually or collectively as forming a shroud, shroud member(s), etc. Tinting (e.g., dye, pigment, and/or other colorant) may be included in layer 130. For example, layer 130 may be tinted to exhibit a visible light transmission of 30-80% to help obscure internal structures in device 10 such as display panel 14P from view when not in use.

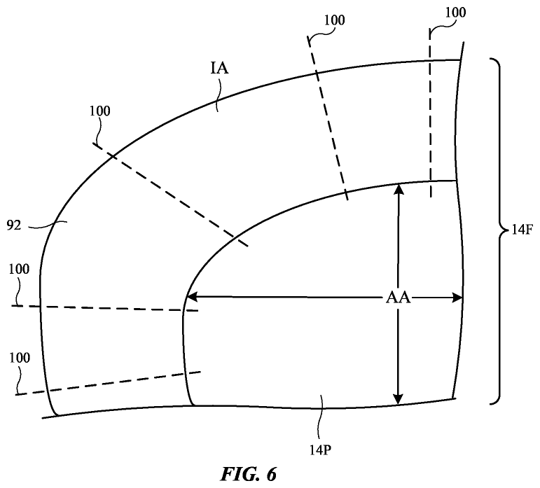

FIG. 6 is a front view of a portion of display 14F and display cover layer 92. The inner and outer surfaces of display cover layer 92 that directly overlap active area AA and display panel 14P may be developable surfaces and/or may include areas of compound curvature. In an illustrative configuration, the inner surface of cover layer 92 in area AA may, as described in connection with FIGS. 4 and 5A, bend about bend axis 94 without exhibiting curvature about any axis orthogonal to axis 94. The outer surface of layer 92 in area AA may be a developable surface or a surface of compound curvature. The use of a developable surface for the inwardly facing side of display cover layer 92 (and, if desired, the use of a developable surface for the inwardly facing side of optional layer 130 of FIG. 5B) may help ensure that display panel 14P is not wrinkled or otherwise damaged during the bending of panel 14P to form a curved display shape that conforms to the shape of the user's head.

Display panel 14P may have an outwardly facing surface in active area AA that is a developable surface. This display panel surface may be adhered to the corresponding inner developable surface of layer 130 or a corresponding inner developable surface of layer 92 or may be spaced apart from the layer 130 and/or the inner surface of layer 92 by an air gap (as examples).

Some or all portions of the inner and outer surfaces of display cover layer 92 in inactive area IA may, if desired, be characterized by compound curvature. This allows the periphery of display 14F to smoothly transition away from the active area and provides an attractive appearance and compact shape for device 10. The compound curvature of display cover layer 92 in inactive area IA may also facilitate placement of the optical components under inactive area IA in desired orientations. If desired, all areas of layer 92 may have compound curvature (e.g., the inner and outer surfaces of layer 92 may have compound curvature in both area IA and area AA).

In the illustrative configuration of FIG. 6, in which display cover layer 92 has a curved peripheral edge and in which the inwardly facing and outwardly facing surfaces of display cover layer 92 have compound curvature in inactive area IA, the cross-sectional profiles of display cover layer 92 taken along each of illustrative lines 100 of FIG. 6 are curved (e.g., the entire peripheral ring-shaped inactive area of display 14F in the FIG. 6 example is covered by a portion of display cover layer 92 with inner and outer surfaces of compound curvature). This type of shape for display cover layer 92 may be produced by glass forming, polymer molding, machining, and/or other display cover layer fabrication techniques. Other arrangements (e.g., configurations in which display cover layer 92 has at least some developable surfaces (inner and/or outer surfaces) in inactive area IA) may also be used. The arrangement of FIG. 6 is illustrative.

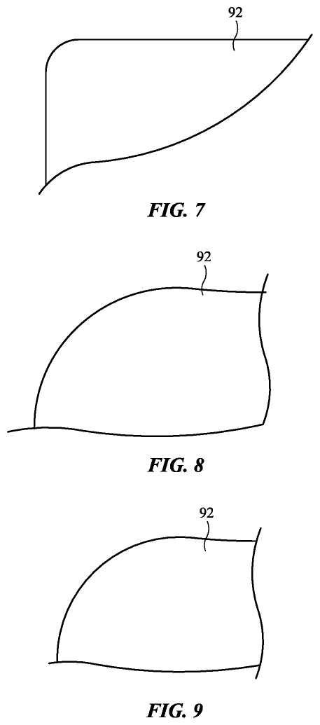

FIGS. 7, 8, and 9 are front views of illustrative upper left portions of display cover layer 92. Device 10 may have symmetrical right-hand cover layer portions. The example of FIG. 7 shows how the peripheral edge of display cover layer 92 may have straight edges (e.g., a generally rectangular shape with straight edges) and rounded corners. In the example of FIG. 8, display cover layer 92 has teardrop shapes on the upper left and right sides. FIG. 9 shows how the upper corners of display cover layer 92 may have sweeping curves (e.g., to help soften the visual appearance of device 10 when viewed from the front).

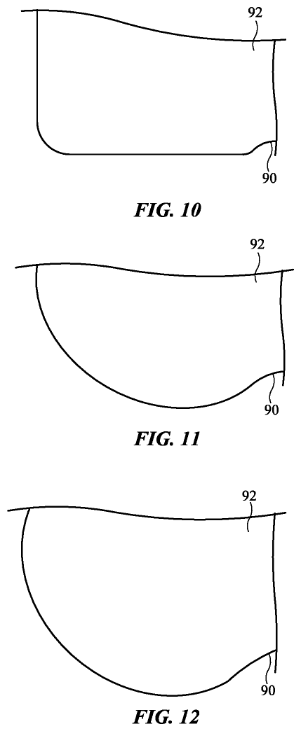

FIGS. 10, 11, and 12 are front views of illustrative lower left portions of display cover layer 92. As shown in FIG. 10, the lower half of cover layer 92 may be characterized by a rectangular shape with rounded corners. Cover layer 92 of FIG. 10 may have an upper portion with a shape of the type shown in FIG. 7 (as an example). In the nose bridge portion of device 10, cover layer 92 may have a recessed curved nose-bridge edge shape (see, e.g., curved edge surface 90). In the illustrative arrangement of FIG. 11, display cover layer 92 has lower left and right sides with teardrop shapes (e.g., shapes that may be used with a display cover layer having upper left and right teardrop shapes of the type shown in FIG. 8). FIG. 12 shows how the lower portion of display cover layer 92 may have a more gradually curved outline.

In general, the upper and lower portions of cover layer 92 may have any suitable outlines when viewed from the front of device 10. The shape used for cover layer 92 may be determined by factors such as aesthetics, size, the ability to facilitate suitable placement for optical components in inactive area IA, the ability to provide desired active area coverage (overlap over active area AA), etc. Any of the illustrative shapes for the upper portion of device 10 shown in FIGS. 7, 8, and/or 9 may be used in combination with any of the illustrative shapes for the lower portion of device 10 shown in FIGS. 10, 11, and 12. The overall shape for cover layer 92 may be symmetric about the nose bridge (e.g., left and right halves of layer 92 may exhibit mirror symmetry). The shapes of FIGS. 7, 8, 9, 10, 11, and 12 are illustrative. Other shapes may be used, if desired.

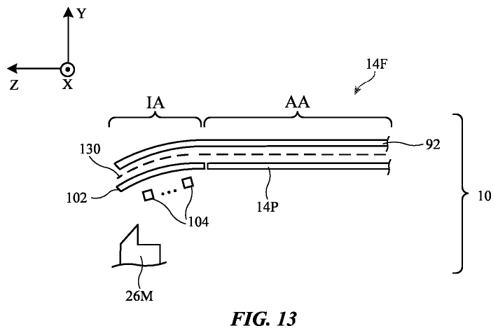

FIG. 13 is an exploded cross-sectional top view of a portion of device 10 showing how display cover layer 92 may have a portion overlapping display panel 14P and a portion overlapping a cosmetic covering structure such as shroud 102 (e.g., a ring-shaped shroud portion sometimes referred to as a shroud trim or shroud trim member, which may optionally be attached in area IA to a shroud canopy that covers display 14F such as optional polymer layer 130). Cosmetic covering structures in inactive area IA may be formed from opaque masking layers (e.g., black ink layers) and/or other coatings on the inner surface of display cover layer 92 and/or on the shroud, from separate structures formed from metal, polymer, glass, or other materials, and/or other structures that can help hide overlapped components 104. Components 104 may include sensors 16 and other input-output devices 22 of FIG. 2. For example, components 104 may be optical components such as components 60, 62, 64, 84, 66, 68, 70, 72, 74, 76, 78, 82, and 80 of FIG. 3. In inactive area IA, cover layer 92 may have curved inner and outer surfaces (e.g., surfaces with compound curvature). Shroud 102 (and, if desired, layer 130 in area IA) may optionally have corresponding inner and outer surfaces (e.g., surfaces with compound curvature). Components 104 may operate through optical component windows in shroud 102 (and optionally in layer 130 in area IA) and corresponding areas in layer 92. These windows may be formed by recesses and/or through-hole openings in shroud 102 (and optionally in layer 130) and/or layer 92, by window members that are installed within openings in shroud 102 (and optionally in layer 130) and/or layer 92, by portions of shroud 102 (and optionally portions of layer 130) and/or layer 92 that exhibit optical transparency sufficient for satisfactory operation of overlapped components, and/or by other structures in shroud 102 (and optionally in layer 130) and/or window 92.

If desired, components 104 may include components such as cameras (e.g., visible and/or infrared image sensors, time-of-flight sensors, structured light three-dimensional sensors, etc.) that are sensitive to optical distortion imposed by the curved shapes of the curved inner and/or outer surface of cover layer 92. For example, a camera or other optical component 104 may operate through a portion of cover layer 92 in inactive area IA that is characterized by an outer surface that has compound curvature and an inner surface with compound curvature or a developable inner surface. In this type of situation, the control circuitry of device 10 may be configured to digitally compensate for the optical distortion introduced as light (e.g., real-world image light) passes through layer 92 to the camera or other optical sensor. As an example, the amount of image distortion imposed by layer 92 (e.g., stretching, shifting, keystoning, barrel distortion, pincushion distortion, and/or other optical distortion) may be measured and characterized for each optical component that operates through layer 92 (e.g., through a portion of layer 92 in inactive area IA that has inner and/or outer surfaces of compound curvature). During operation of device 10, the image data captured by a camera and/or other sensor data that is gathered by an optical component overlapped by layer 92 may be compensated accordingly (e.g., an equal and opposite amount of digital image warping may be applied to the captured image data, thereby removing the known distortion effects of layer 92). In this way, high quality (undistorted) images and/or other sensor data may be gathered by cameras and/or other optical components that operate through curved portions of layer 92. This allows layer 92 to be provided with an attractive shape (e.g., a shape with one or more surfaces characterized by compound curvature).

When assembled into device 10, display cover layer 92 and shroud 102 (and optionally layer 130) may be mounted to an exposed edge portion of a polymer housing structure, a metal housing wall, or other housing structure in main housing portion 26M. As an example, main housing portion 26M may have a polymer sidewall member that runs around the periphery of display cover layer 92 and that supports the peripheral edge of display cover layer 92. Shroud 102 may have a ring shape that runs along the edge of display cover layer 92 in inactive area IA. In an illustrative configuration, adhesive is used to attach display cover layer 92 to shroud 102 (and/or layer 130) and adhesive is used to attach shroud 102 (and/or layer 130) to the exposed front edge of the sidewall in main housing portion 26M. Components 104 may be attached to shroud 102 (and/or layer 130) and/or may be supported on internal housing structures (e.g., brackets, frame members, etc.) in alignment with optical windows in shroud 102 (and/or layer 130) and corresponding portions of layer 92.

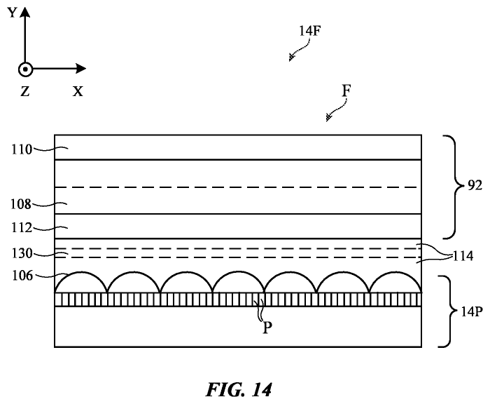

FIG. 14 is a cross-sectional side view of a portion of display 14F. In the example of FIG. 14, display panel 14P is a three-dimensional display panel having an array of pixels P overlapped by lenticular lenses 106 (e.g., display panel 14P is an autostereoscopic display that produces glasses-free three-dimensional images for viewers such as viewer 50 of FIG. 1). Lenses 106 may, as an example, be formed from semicylindrical lens elements that are elongated along columns of pixels (e.g., lens elements that extend parallel to the Z dimension in the example of FIG. 14). If desired, lenses 106 may be omitted (e.g., display panel 14P may have an array of pixels P that are not overlapped by lenses 106 to form a two-dimensional display).

An air gap such as gap 114 may separate display panel 14P of display 14F from display cover layer 92. Optional layer 130 may be formed within gap 114 of FIG. 14, so that layer 130 has an outer surface that is separated from layer 92 by a first air gap and an opposing inner surface that is separated from lenses 106 and pixels P of display panel 14P by a second air gap. In arrangements in which lenses 106 are present, air gap 114 (and the resulting absence of direct contact between the inner surface of layer 130 and lenses 106) may allow lenses 106 to operate satisfactorily. Display cover layer 92 and optional layer 130 may be formed from transparent material such as glass, polymer, clear ceramic, crystalline material such as sapphire, one or more sublayers of these materials and/or other materials that have been laminated together (e.g., using adhesive, etc.), etc. Configurations in which layer 92 is a glass layer and layer 130 is a polymer layer may sometimes be described herein as an example.

Coatings may be provided on one or more of the layers in display cover layer 92. As shown in the illustrative configuration of FIG. 14, display cover layer 92 may include, for example, a layer such as layer 108 that is formed from one or more sublayers (e.g., layer(s) of glass and/or polymer), a polymer layer that helps provide layer 92 with safety glass functionality (see, e.g., illustrative polymer film 112, which has been attached to the inner surface of glass layer 108 to form a layer of laminated glass), and coating 110 on the front (outwardly facing) surface of layer 92 (e.g., the outer surface of glass layer 108). Coating 110 may be, for example, an antireflection coating formed from one or more inorganic dielectric layers and/or other layers with thicknesses and refractive index values selected to minimize visible light reflections from the outermost surface of layer 92 and help maintain a desired appearance (e.g., a neutral tint) for layer 92. If desired, display panel 14P may be a touch sensitive display (e.g., a display that is overlapped by or incorporates capacitive touch sensor circuitry). In configurations in which display 14F is touch sensitive, the outermost surface of layer 92 may be coated with an oleophobic coating layer (e.g., a fluoropolymer layer).

To help strengthen layer 92, layer 108 may be formed from chemically strengthened glass (e.g., a glass layer that has been treated in an ion-exchange bath to place the exterior surfaces of the glass layer under compression relative to the interior of the glass layer). This may help layer 108 resist scratching and cracks. Layer 108 may be formed from a single glass layer, a single polymer layer, a stack of two laminated glass layers (e.g., first and second glass layers laminated together with a layer of polymer), a stack of two polymer layers, three or more polymer and/or glass layers, etc. If desired, layer 108 may be formed from a hybrid stack of layers that includes one or more glass layers attached to one or more polymer layers. As an example, layer 92 may include a rigid structural polymer layer that is covered with a thin glass layer (e.g., a glass layer attached to the structural polymer layer using heat and/or pressure or a glass layer attached to the structural polymer layer using a layer of polymer adhesive). The thin glass layer in this type of arrangement may help protect the structural polymer layer from scratches.

One or more of the structures in layer 92 (e.g., coating 110, the layer(s) forming layer 108, layer 112, optional layer 130, etc.) may, if desired, be provided with a dye, pigment, or other colorant that creates a desired neutral tint (e.g., gray or black) or non-neutral tint (e.g., red). Thin metal coatings, polarizers, and/or other structures may also be incorporated into layer 92 to help provide layer 92 with desired optical properties and/or to provide layer 92 with a desired external appearance.

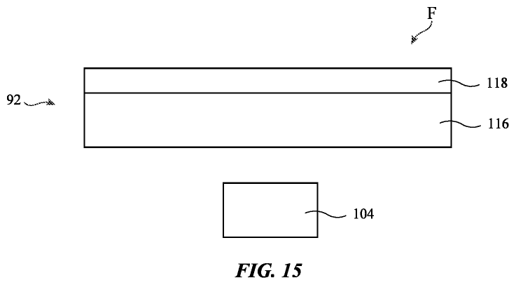

If desired, the portion of layer 92 that overlaps optical components 104 and/or other portions of layer 92 may be provided with a coating that helps prevent scratches that could adversely affect optical quality for components 104. As shown in FIG. 15, for example, display cover layer 92 may have a transparent layer such as transparent layer 116 (e.g., one or more layers of polymer, glass, and/or other transparent layers such as layer 108 of FIG. 14). Transparent layer 116 may be covered with one or more coating layers such as coating layer 118. Layer 118 may be a thin-film layer formed from an inorganic material (e.g., an oxide, nitride, diamond-like carbon etc.) that helps resist scratches. This type of approach may be used, for example, to ensure that the portion of display cover layer 92 that overlaps optical component 104 does not become hazy from scratches when layer 116 is formed from a material such as polymer that may be prone to scratching when exposed to excessive rubbing from sharp external objects. Layer 118 may sometimes be referred to as a hard coat and may have a higher hardness (e.g., a higher Mohs hardness) than layer 116. Layer 118 may be a thin-film coating with a thickness of less than 3 microns, less than 2 microns, less than 1 micron, less than 0.5 microns, or other suitable thickness.

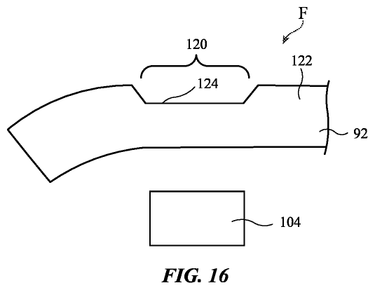

Another way in which to help prevent undesired scratches on the surface of display cover layer 92 where layer 92 overlaps optical components 104 is illustrated in the cross-sectional side view of display cover layer 92 of FIG. 16. As this example demonstrates, the outer surface of display cover layer 92 may be provided with a recess such as recess 120 (e.g., a shallow circular depression or a depression with a rectangular shape or other footprint). This places recessed display cover layer surface 124 of recess 120 below surrounding external surfaces 122 of layer 92. When device 10 is laid on a tabletop or other surface, the unrecessed portion of the surface of layer 92 (external surface 122) will contact the tabletop surface and will thereby help prevent the tabletop surface from contacting the recessed portion of the surface of layer 92 (surface 124). As a result, recessed surface 124, which overlaps component 104, will remain free of scratches. Haze will therefore not generally develop in the area of layer 92 that overlaps component 104, even when layer 92 is exposed to excessive wear.

Layer 92 may be formed from materials having optical properties that are compatible with overlapped optical components 104. For example, if an optical component that is overlapped by a portion of layer 92 in inactive area IA is configured to operate at visible and infrared wavelengths, that portion of layer 92 may be provided with sufficient visible light and infrared light transparency to allow the overlapped component to operate satisfactorily at visible and infrared wavelengths. In arrangements in which the material from the bulk of layer 92 does not have desired optical properties for an optical component, an optical component window member (e.g., a disk of window material such as a disk of infrared-transparent and, if desired, visible-transparent glass or other inserted window member) may be mounted within an opening in layer 92 overlapping the optical component.

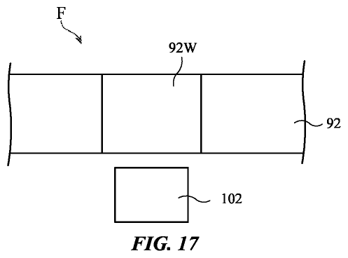

Consider, as an example, an arrangement in which layer 92 is transparent to visible light but has low transmission at infrared wavelengths. An optical component in this type of arrangement may operate at infrared wavelengths. To ensure that the optical component can transmit and/or receive infrared light through layer 92, layer 92 may be provided with a through-hole opening and an infrared-transparent optical component window member such as an infrared-transparent disk. The infrared-transparent window member may be formed from a different material than the material forming layer 92 and may be mounted within the through-hole opening in layer 92. This type of arrangement is shown in the cross-sectional side view of FIG. 17 in which display cover layer 92 has been provided with optical component window member 92 W in a through-hole opening in layer 92. Member 92 W may be a glass optical component window member that is transparent to infrared light (and optionally transparent to visible light), whereas surrounding portions of layer 92 may be formed from different material (e.g., polymer, different glass material, etc.). By providing an infrared-transparent window in layer 92, the infrared optical component (e.g., optical component 102 of FIG. 17) can transmit and/or received infrared light through display cover layer 92 (e.g., through the window in the display cover layer), even when layer 92 has been formed from materials that are not infrared-transparent. This approach may be used to provide an optical component window with any suitable optical properties that are different than those of the rest of layer 92 (e.g., desired amounts of opacity, light transmission, reflection, absorption, and/or haze level, desired polarization properties, etc.).

In accordance with an embodiment, a head-mounted device is provided that includes a head-mounted support structure; rear-facing displays supported by the head-mounted support structure that are configured to provide visual content to eye boxes at a rear side of the head-mounted support structure; a publicly viewable forward-facing display panel that has pixels configured to display an image; and a display cover layer overlapping the publicly viewable forward-facing display panel, the display cover layer has a compound-curvature surface overlapping the pixels.

In accordance with another embodiment, the publicly viewable forward-facing display panel includes a flexible display panel on which the pixels are located, the flexible display panel is bent about a bend axis, and the head-mounted support structure has a curved rear surface configured to conform to a curved face surface.

In accordance with another embodiment, the display cover layer includes a glass layer.

In accordance with another embodiment, the head-mounted device includes a polymer layer between the glass layer and the flexible display panel, a first air gap separates the polymer layer from the glass layer, and a second air gaps separates the flexible display panel from the polymer layer.

In accordance with another embodiment, the display cover layer includes an antireflection coating on the glass layer.

In accordance with another embodiment, the head-mounted device includes optical components overlapped by a portion of the display cover layer with the compound-curvature surface.

In accordance with another embodiment, the optical components include cameras, the head-mounted device includes a ring-shaped polymer member forming a cosmetic covering structure that overlaps the cameras and that surrounds the pixels.

In accordance with another embodiment, the display cover layer includes a polymer layer with a recess that overlaps a given one of the optical components.

In accordance with another embodiment, the optical components include a flicker sensor and an ambient light sensor.

In accordance with another embodiment, the optical components include pose cameras configured to measure device motion and scene cameras configured to capture real-time pass-through video that is displayed on the rear-facing displays.

In accordance with another embodiment, the optical components include a pair of structured light cameras and a time-of-flight camera.

In accordance with another embodiment, the display cover layer includes a polymer layer having a through-hole opening containing an infrared-transparent window member that overlaps one of the optical components.

In accordance with another embodiment, the head-mounted device includes a scratch-resistant hard coat on the display cover layer.

In accordance with another embodiment, the forward-facing display panel includes lenticular lenses.

In accordance with another embodiment, the forward-facing display panel has a nose bridge recess.

In accordance with an embodiment, a head-mounted device is provided that includes a head-mounted support structure; a left lens on a left side of the head-mounted support structure; a right lens on the right side of the head-mounted support structure; left and right displays configured to provide respective left and right rear images viewable from left and right eye boxes through the left and right lenses; a publicly viewable display panel facing away from the left and right displays, the publicly viewable display panel has pixels configured to display a publicly viewable image; and a display cover layer, a first portion of the display cover layer overlaps that pixels, a second portion of the display cover layer surrounds the first portion of the display cover layer in a ring shape without overlapping the pixels, and the second portion of the display cover layer has a surface with compound curvature.

In accordance with another embodiment, the head-mounted device includes an ambient light sensor overlapped by the second portion of the display cover layer, a light source overlapped by the second portion of the display cover layer that is configured to provide infrared illumination in response to an ambient light measurement with the ambient light sensor, and a pair of cameras that are overlapped by the second portion of the display cover layer and that are configured to capture infrared images while the infrared illumination is provided.

In accordance with another embodiment, the publicly viewable display panel is bent about a bend axis.

In accordance with another embodiment, the second portion of the display cover layer has a curved peripheral edge.

In accordance with another embodiment, the display cover layer includes laminated glass.

In accordance with another embodiment, the pixels form an active display area in which the publicly viewable image is displayed, the active display area has a curved peripheral edge, and the active area has a nose-bridge recess.

In accordance with another embodiment, the head-mounted device includes an antireflection coating on the laminated glass and an optical components that emits infrared light through the display cover layer.

In accordance with another embodiment, the optical component includes a structured light three-dimensional camera.

In accordance with another embodiment, the first portion of the display cover layer has a surface of compound curvature.

In accordance with an embodiment, a head-mounted device is provided that includes a head-mounted support structure; a first display and a first lens that are supported by the head-mounted support structure and that are configured to provide a first image to a first eye box; a second display and a second lens that are supported by the head-mounted support structure and that are configured to provide a second image to a second eye box; a forward-facing display that faces away from the first and second displays; and a display cover layer that overlaps the forward-facing display and that has a portion with a compound-curvature surface.

In accordance with another embodiment, the forward-facing display includes a flexible display panel that is bent about a bend axis and has a developable surface.

In accordance with another embodiment, the display cover layer has a portion that overlaps the flexible display panel and that has a developable surface.

In accordance with another embodiment, the display cover layer is covered with surfaces of compound curvature.

In accordance with an embodiment, a head-mounted device having a front and rear is provided that includes a head-mounted housing having a front housing layer at the front; a first display and a first lens that are supported by the head-mounted housing and that are configured to provide a first image to a first eye box at the rear; a second display and a second lens that are supported by the head-mounted housing and that are configured to provide a second image to a second eye box at the rear; an optical component that is overlapped by a portion of the front housing layer that has a compound-curvature surface.

In accordance with another embodiment, the head-mounted device includes a bent display panel configured to produce an image viewable through a portion of the front housing layer.

In accordance with another embodiment, the front housing layer includes a display cover layer and the compound-curvature surface includes an outer surface of the display cover layer that covers all of the display cover layer.

In accordance with another embodiment, the optical component includes a camera configured to operate through the display cover layer.

In accordance with an embodiment, a head-mounted device having a front and rear is provided that includes a head-mounted housing; a first display and a first lens in the head-mounted housing that are configured to provide a first image to a first eye box at the rear; a second display and a second lens in the head-mounted housing that are configured to provide a second image to a second eye box at the rear; a display panel that has a curved cross-sectional profile and a developable surface; and a display cover layer at the front that overlaps that bent display panel, the display cover layer has opposing inner and outer surfaces, the outer surface has compound curvature, the inner surface is a developable surface, and the display panel is attached to the inner surface of the display cover layer.

The foregoing is merely illustrative and various modifications can be made to the described embodiments. The foregoing embodiments may be implemented individually or in any combination.

What is claimed is:

1. A head-mounted device, comprising:
a head-mounted support structure;
rear-facing displays supported by the head-mounted support structure that are configured to provide visual content to eye boxes at a rear side of the head-mounted support structure;
a publicly viewable forward-facing display panel that has pixels configured to display an image; and
a display cover layer overlapping the publicly viewable forward-facing display panel, wherein the display cover layer has a compound-curvature surface overlapping the pixels.

2. The head-mounted device defined in claim 1 wherein the publicly viewable forward-facing display panel comprises a flexible display panel on which the pixels are located, wherein the flexible display panel is bent about a bend axis, and wherein the head-mounted support structure has a curved rear surface configured to conform to a curved face surface.

3. The head-mounted device defined in claim 2 wherein the display cover layer comprises a glass layer.

4. The head-mounted device defined in claim 3 further comprising a polymer layer between the glass layer and the flexible display panel, wherein a first air gap separates the polymer layer from the glass layer, and wherein a second air gaps separates the flexible display panel from the polymer layer.

5. The head-mounted device defined in claim 3 wherein the display cover layer comprises an antireflection coating on the glass layer.

6. The head-mounted device defined in claim 1 further comprising optical components overlapped by a portion of the display cover layer with the compound-curvature surface.

7. The head-mounted device defined in claim 6 wherein the optical components comprise cameras, the head-mounted device further comprising a ring-shaped polymer member forming a cosmetic covering structure that overlaps the cameras and that surrounds the pixels.

8. The head-mounted device defined in claim 6 wherein the display cover layer comprises a polymer layer with a recess that overlaps a given one of the optical components.

9. The head-mounted device defined in claim 6 wherein the optical components comprise a flicker sensor and an ambient light sensor.

10. The head-mounted device defined in claim 6 wherein the optical components comprises pose cameras configured to measure device motion and scene cameras configured to capture real-time pass-through video that is displayed on the rear-facing displays.

11. The head-mounted device defined in claim 6 wherein the optical components comprise a pair of structured light cameras and a time-of-flight camera.

12. The head-mounted device defined in claim 6 wherein the display cover layer comprises a polymer layer having a through-hole opening containing an infrared-transparent window member that overlaps one of the optical components.

13. The head-mounted device defined in claim 6 further comprising a scratch-resistant hard coat on the display cover layer.

14. The head-mounted device defined in claim 1 wherein the forward-facing display panel comprises lenticular lenses.

15. The head-mounted device defined in claim 1 wherein the forward-facing display panel has a nose bridge recess.

16. A head-mounted device, comprising:
a head-mounted support structure;
a left lens on a left side of the head-mounted support structure;
a right lens on the right side of the head-mounted support structure;
left and right displays configured to provide respective left and right rear images viewable from left and right eye boxes through the left and right lenses;
a publicly viewable display panel facing away from the left and right displays, wherein the publicly viewable display panel has pixels configured to display a publicly viewable image; and
a display cover layer, wherein a first portion of the display cover layer overlaps that pixels, wherein a second portion of the display cover layer surrounds the first portion of the display cover layer in a ring shape without overlapping the pixels, and wherein the second portion of the display cover layer has a surface with compound curvature.

17. The head-mounted device defined in claim 16 further comprising: an ambient light sensor overlapped by the second portion of the display cover layer, a light source overlapped by the second portion of the display cover layer that is configured to provide infrared illumination in response to an ambient light measurement with the ambient light sensor, and a pair of cameras that are overlapped by the second portion of the display cover layer and that are configured to capture infrared images while the infrared illumination is provided.

18. The head-mounted device defined in claim 16 wherein the publicly viewable display panel is bent about a bend axis.

19. The head-mounted device defined in claim 16 wherein the second portion of the display cover layer has a curved peripheral edge.

20. The head-mounted device defined in claim 16 wherein the display cover layer comprises laminated glass.

21. The head-mounted device defined in claim 20 wherein the pixels form an active display area in which the publicly viewable image is displayed, wherein the active display area has a curved peripheral edge, and wherein the active area has a nose-bridge recess.

22. The head-mounted device defined in claim 21 further comprising an antireflection coating on the laminated glass and an optical components that emits infrared light through the display cover layer.

23. The head-mounted device defined in claim 22 wherein the optical component comprises a structured light three-dimensional camera.

24. The head-mounted device defined in claim 23 wherein the first portion of the display cover layer has a surface of compound curvature.

25. A head-mounted device, comprising:
a head-mounted support structure;
a first display and a first lens that are supported by the head-mounted support structure and that are configured to provide a first image to a first eye box;
a second display and a second lens that are supported by the head-mounted support structure and that are configured to provide a second image to a second eye box;
a forward-facing display that faces away from the first and second displays; and
a display cover layer that overlaps the forward-facing display and that has a portion with a compound-curvature surface.

26. The head-mounted device defined in claim 25 wherein the forward-facing display comprises a flexible display panel that is bent about a bend axis and has a developable surface.

27. The head-mounted device defined in claim 26 wherein the display cover layer has a portion that overlaps the flexible display panel and that has a developable surface.

28. The head-mounted device defined in claim 26 wherein the display cover layer is covered with surfaces of compound curvature.

29. A head-mounted device having a front and rear, comprising:
a head-mounted housing having a front housing layer at the front;
a first display and a first lens that are supported by the head-mounted housing and that are configured to provide a first image to a first eye box at the rear;
a second display and a second lens that are supported by the head-mounted housing and that are configured to provide a second image to a second eye box at the rear;
an optical component that is overlapped by a portion of the front housing layer that has a compound-curvature surface.

30. The head-mounted device defined in claim 29 further comprising a bent display panel configured to produce an image viewable through a portion of the front housing layer.

31. The head-mounted device defined in claim 30 wherein the front housing layer comprises a display cover layer and wherein the compound-curvature surface comprises an outer surface of the display cover layer that covers all of the display cover layer.

32. The head-mounted device defined in claim 31 wherein the optical component comprises a camera configured to operate through the display cover layer.

33. A head-mounted device having a front and rear, comprising:
a head-mounted housing;
a first display and a first lens in the head-mounted housing that are configured to provide a first image to a first eye box at the rear;
a second display and a second lens in the head-mounted housing that are configured to provide a second image to a second eye box at the rear;
a display panel that has a curved cross-sectional profile and a developable surface; and
a display cover layer at the front that overlaps that bent display panel, wherein the display cover layer has opposing inner and outer surfaces, wherein the outer surface has compound curvature, wherein the inner surface is a developable surface, and wherein the display panel is attached to the inner surface of the display cover layer.
